(19) United States
(12) Patent Application Publication
(10) Pub. No.: US 2020/0027342 A1
(43) Pub. Date: Jan. 23, 2020

(54) VEHICLE-MOUNTED DEVICE AND COMPUTER PROGRAM

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventor: Atsushi Shimizu, Yokkaichi, Mie (JP)

(21) Appl. No.: 16/471,112

(22) PCT Filed: Dec. 7, 2017
(86) PCT No.: PCT/JP2017/043914

§ 371 Date: Jun. 19, 2019

(30) Foreign Application Priority Data
Dec. 22, 2016 (JP) 2016-249909

(51) Int. Cl. G08G 1/095; G08G 1/052; B60Q 9/00

(52) U.S. Cl. CPC G08G 1/095; B60Q 9/00; G08G 1/052

(57) ABSTRACT

Provided are a vehicle-mounted device and a computer program that make it possible to recognize that a vehicle can be stopped at a red signal light. The vehicle-mounted device includes: a vehicle information acquisition unit configured to acquire position information and speed information of a vehicle; an intersection information acquisition unit configured to acquire position information of one or a plurality of intersections in a traveling direction of the vehicle; a signal information acquisition unit configured to acquire signal information of a signal light device installed at the intersection; a determination unit configured to determine whether an event that stops the vehicle has occurred; and an output unit configured to output, if it is determined that the event has occurred, stop information relating to at least one of a time that will elapse until the vehicle is stopped at a red signal light and a stop position.

### CROSS-REFERENCE TO RELATED APPLICATIONS

This application is the U.S. national stage of PCT/JP2017/043914 filed Dec. 7, 2017, which claims priority of Japanese Patent Application No. JP 2016-249909 filed Dec. 22, 2016, the contents of which are incorporated herein.

### TECHNICAL FIELD

The present disclosure relates to a vehicle-mounted device and a computer program.

### BACKGROUND

There are devices in practical use that stop the engine of a vehicle when the vehicle has stopped (idling stop), thus suppressing exhaust gas from being generated through idling.

Also, in order to effectively perform idling stop, an engine stop control device is disclosed that estimates a stop time that will elapse until the vehicle starts traveling, based on the distance to a downstream intersection and the signal information on the downstream intersection, when a vehicle has stopped to wait for a traffic light to change, and determines whether it is appropriate to perform idling stop, based on the estimated stop time (see JP 2007-56734A).

However, the device of JP 2007-56734A estimates the stop time when a vehicle stops, but does not estimate when a traveling vehicle will stop next. When driving a vehicle, the driver may desire to stop the vehicle only for a short period of time in order to, for example, perform an operation other than driving. At such a time, the driver can stop the vehicle in a parking lot or the like, but may possibly utilize a stop at a red signal light if such an operation can be handled in a short period of stop time. However, it is not possible to recognize whether the vehicle can be stopped at a red signal light when the vehicle is being driven.

Therefore, an object is to provide a vehicle-mounted device that makes it possible to recognize that a vehicle can be stopped at a red signal light, and a computer program for controlling the vehicle-mounted device.

### SUMMARY

A vehicle-mounted device according to the present disclosure includes: a vehicle information acquisition unit configured to acquire position information and speed information of a vehicle; an intersection information acquisition unit configured to acquire position information of one or a plurality of intersections in a traveling direction of the vehicle; a signal information acquisition unit configured to acquire signal information of a signal light device installed at the intersection; a determination unit configured to determine whether an event that stops the vehicle has occurred; and an output unit configured to output, if the determination unit determines that the event has occurred, stop information relating to a stop of the vehicle at a red signal light, based on the position information and the speed information of the vehicle, the position information of the intersection, and the signal information.

A computer program according to the present disclosure is for causing a computer to control a vehicle-mounted device, the program causing the computer to execute: processing for acquiring position information and speed information of a vehicle; processing for acquiring position information of one or a plurality of intersections in a traveling direction of the vehicle; processing for acquiring signal information of a signal light device installed at the intersection; processing for determining whether an event that stops the vehicle has occurred; and processing for outputting, if it is determined that the event has occurred, stop information relating to a stop of the vehicle at a red signal light, based on the position information and the speed information of the vehicle, the position information of the intersection, and the signal information.

### Effects of the Present Disclosure

According to the present disclosure, it is possible to recognize that a vehicle can be stopped at a red signal light.

### BRIEF DESCRIPTION OF DRAWINGS

FIG. 1 is a block diagram showing an example of the configuration of a vehicle-mounted device according to the present embodiment.

FIG. 2 is a schematic diagram showing an example of the traveling state of a vehicle to which the vehicle-mounted device according to the present embodiment has been mounted.

FIG. 3 is a diagram illustrating an example of the method for specifying an intersection by the vehicle-mounted device according to the present embodiment.

FIG. 4 is a diagram illustrating an example of the output of stop information provided by the vehicle-mounted device according to the present embodiment.

FIG. 5 is a flowchart illustrating an example of the processing procedure executed by the vehicle-mounted device according to the present embodiment when the speed of the vehicle is not changed.

FIG. 6 is a diagram illustrating an example of the method for calculating a recommended speed by the vehicle-mounted device according to the present embodiment.

FIG. 7 is a diagram illustrating another example of the output of stop information provided by the vehicle-mounted device according to the present embodiment.

FIG. 8 is a flowchart illustrating an example of the processing procedure executed by the vehicle-mounted device according to the present embodiment when the speed of the vehicle is changed.

### DETAILED DESCRIPTION OF PREFERRED EMBODIMENTS

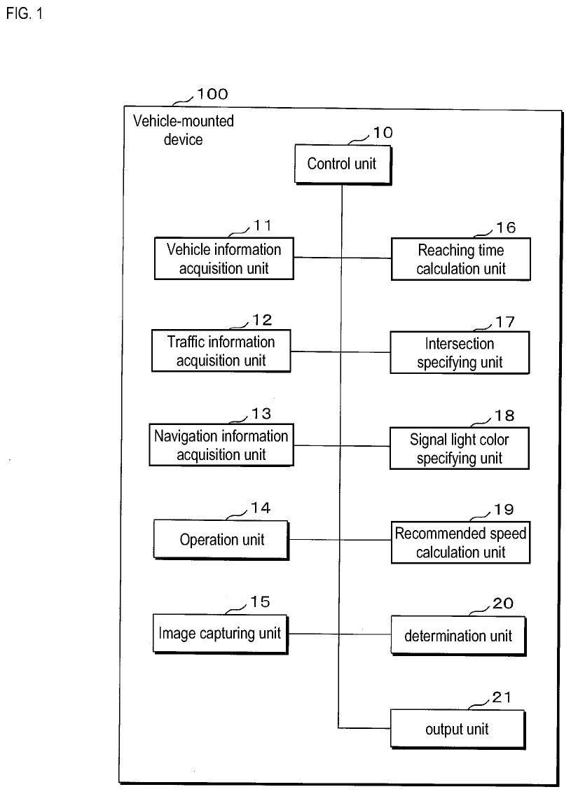

Hereinafter, an embodiment of the present disclosure will be described with reference to the drawings. FIG. 1 is a block diagram showing an example of the configuration of a vehicle-mounted device 100 according to the present embodiment. The vehicle-mounted device 100 includes a control unit 10 that performs overall control of the device, a vehicle information acquisition unit 11, a traffic information acquisition unit 12, a navigation information acquisition unit 13, an operation unit 14, an image capturing unit 15, a reaching time calculation unit 16, an intersection specifying unit 17, a signal light color specifying unit 18, a recommended speed calculation unit 19, a determination unit 20, an output unit 21, and so forth.

The vehicle information acquisition unit 11 acquires the position information and the speed information of a vehicle to which the vehicle-mounted device 100 has been mounted. The position information may be an absolute position, such as that of latitude and longitude, or may be a relative position (the distance and the azimuth) from a reference position. The position information can be repeatedly acquired from a positioning system (not shown) such as a global positioning system (GPS), each time a predetermined time has elapsed. The speed information can be acquired from a vehicle speed sensor (not shown). The speed information can also be calculated based on the position information of two locations and the time required to move between the two locations.

The traffic information acquisition unit 12 has the function of an intersection information acquisition unit, and acquires the position information of one or a plurality of intersections in the traveling direction of the vehicle. The position information of an intersection can be acquired from, for example, a roadside device such as an optical beacon and an intelligent transport system (ITS) radio set. The position information may be an absolute position, such as that of latitude and longitude, or may be a relative position from a reference position.

The traffic information acquisition unit 12 has the function of a signal information acquisition unit, and acquires the signal information of the signal light device installed at the intersection. The signal information includes, for example, a cycle length, a split, an offset, and the display duration of each light color (e.g., green, yellow, red). The signal information can be acquired from a roadside device such as a traffic signal controller or a signal control device (both not shown).

The determination unit 20 determines whether an event that stops the vehicle has occurred. The event that stops the vehicle may be, for example, an event in which the driver desires to stop the vehicle (for a relatively short period of time, e.g., 30 seconds or 1 minute) to perform an operation (including, for example, picking up a piece of baggage on the passenger seat or the back seat, operating a mobile phone, dressing or undressing, and cleaning a window or a mirror) other than driving.

The output unit 21 includes, for example, a center display, a head-up display (HUD), a meter and so forth, and can output characters, or figures and charts. In addition, the output unit 21 includes a speaker, and can output audio.

If the determination unit 20 determines that an event that stops the vehicle has occurred, the output unit 21 outputs stop information relating to a stop of the vehicle at a red signal light. The stop information is information relating to a vehicle stopping at a red signal light, and includes, for example, the time that will elapse until the vehicle is stopped (the time it will take to reach the intersection), the stop position, the stop time (the remaining duration of the red signal light), and so forth. The stop position may be any information representing at which position (distance) the vehicle can be stopped from the current location of the vehicle, and may be, for example, the distance between the vehicle and an intersection at which the vehicle can be stopped, or information indicating at what number intersection in the traveling direction the vehicle can be stopped. The output of the stop information may be a display of characters or figures, or may be an audio output.

With the above-described configuration, the driver can obtain at least one of the time that elapses and the distance that is traveled until the vehicle stops at a red signal light, and therefore can recognize that the vehicle can be stopped at a red signal light. In addition, the driver can recognize when he or she can deal with an event that stops the vehicle.

Next, the details of the vehicle-mounted device 100 according to the present embodiment will be described. If a vehicle is to be stopped at a red signal light, there may be a case where the vehicle travels without changing the speed, and a case where it is recommended to change the speed of the vehicle (the vehicle travels at a recommended speed). First, the case where the vehicle travels without changing the speed will be described.

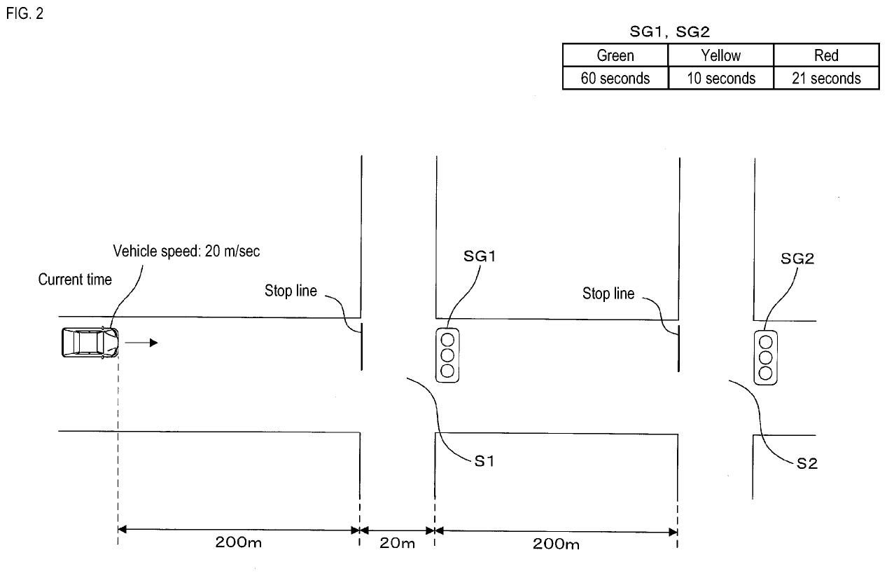

FIG. 2 is a schematic diagram showing an example of the traveling state of a vehicle to which the vehicle-mounted device 100 according to the present embodiment has been mounted. As shown in FIG. 2, it is assumed that two intersections S1 and S2 are present in the traveling direction of the vehicle. Note that although the drawing shows two intersections for the sake of convenience, the number of intersections is not limited to two. A signal light device SG1 is installed at the intersection S1, and a signal light device SG2 is installed at the intersection S2. It is assumed that the signal information of signal light devices SG1 and SG2 is such that the cycle length is 121 seconds, the display duration of a green light color is 60 seconds, the display duration of a yellow light color is 1 second, the display duration of a red light color is 60 seconds, and the offset between the signal light devices SG1 and SG2 is 5 seconds. Note that the offset is not limited to 5 seconds.

The speed of the vehicle is 20 m/sec. The distance from the current position of the vehicle to the stop line of the intersection S1 is 200 m, the distance from the current position of the vehicle to the stop line of the intersection S2 is 420 m, and the distance from the entrance to the exit of the intersection S1 is 20 m.

The reaching time calculation unit 16 calculates, based on the position information and the speed information of the vehicle and the position information of each of the plurality of intersections, the reaching times that elapse until the vehicle reaches the respective intersections. The reaching time that will elapse until the vehicle reaches each intersection can be calculated based on the distance between the vehicle and the intersection, and the speed of the vehicle.

In the example shown in FIG. 2, the reaching time that will elapse until the vehicle reaches the intersection S1 is 10 seconds. Provided that the vehicle will not be stopped at the intersection S1 at a red signal light, the reaching time that will elapse until the vehicle reaches the intersection S2 is 21 seconds.

The intersection specifying unit 17 specifies, based on the signal information of the signal light device at each of the intersections, an intersection at which the signal light will be red at the time at which the corresponding reaching time has elapsed from the current time.

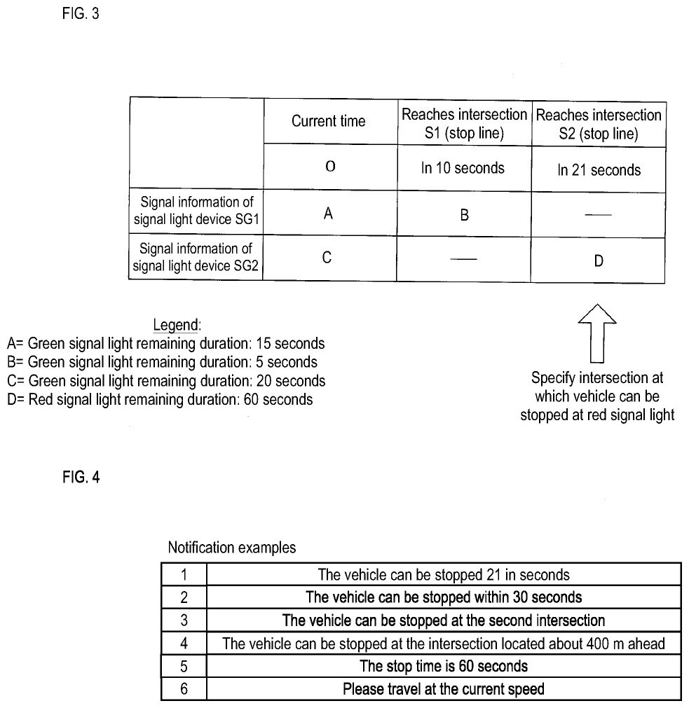

FIG. 3 is a diagram illustrating an example of the method for specifying the intersection by the vehicle-mounted device 100 according to the present embodiment. As shown in FIG. 3, assuming that the current time is 0, the vehicle will reach the intersection S1 (stop line) in 10 seconds, as calculated by the reaching time calculation unit 16. The vehicle will reach the intersection S2 (stop line) in 21 seconds

Assuming that the signal light device SG1 currently displays a green signal light, and the remaining duration (the remainder of the display duration) is 15 seconds, the signal light device SG1 will display a green signal light at the time (10 seconds later) at which the vehicle has reached the intersection S1, and the remaining duration is 5 seconds.

Since the signal light is green at the time at which the vehicle has reached the intersection S1, the vehicle will pass the intersection S1 without being stopped.

Assuming that the signal light device SG2 currently displays a green signal light, and the remaining duration (the remainder of the display duration) is 20 seconds (the offset from the signal light device SG1 is 5 seconds), the signal light device SG2 will display a red signal light at the time (21 seconds later) at which when the vehicle has reached the intersection S2, and the remaining duration of the red signal light is 60 seconds.

As described above, assuming that the light color of the signal light device is green at the intersection S1 at the time at which the vehicle reaches the intersection S1, and the light color of the signal light device is red at the intersection S2 at the time at which the vehicle reaches the intersection S2, the intersection specifying unit 17 specifies the intersection S2. The intersection S2 is an intersection at which the vehicle can be stopped at a red signal light.

FIG. 4 is a diagram illustrating an example of output of the stop information provided by the vehicle-mounted device 100 according to the present embodiment. Note that the notification examples (output examples) illustrated in FIG. 4 may be an audio output, or may be output by displaying characters or the like.

Notification Example 1 is “The vehicle can be stopped in 21 seconds”, which is an example in which an accurate notification has been made of the time that will elapse until the vehicle can be stopped. Notification Example 2 is “The vehicle can be stopped within 30 seconds”, which is an example in which a notification has been made with the time that will elapse until the vehicle can be stopped being an approximate value (e.g., the maximum value).

As shown in Notification Examples 1 and 2, the output unit 21 can output, as the stop information, the reaching time that will elapse until the vehicle reaches a specified intersection. Accordingly, the driver can know when the vehicle can be stopped (the time that will elapse until the vehicle is stopped) if the driver desires to stop the vehicle at a red signal light, and therefore can recognize that the vehicle can be stopped at a red signal light.

Notification Example 3 is “The vehicle can be stopped at the second intersection”, which is an example in which a notification is made with an intersection (at what number intersection the vehicle can be stopped) as the position at which the vehicle can be stopped. Notification Example 4 is “The vehicle can be stopped at the intersection located about 400 m ahead”, which is an example in which a notification is made with a distance indicating the position at which the vehicle can be stopped.

As shown in Notification Examples 3 and 4, the output unit 21 can output the position of the specified intersection as the stop information. Accordingly, the driver can know where the vehicle can be stopped (the distance that is traveled until the vehicle is stopped) if the driver desires to stop the vehicle at a red signal light, and therefore can recognize that the vehicle can be stopped at a red signal light.

Notification Example 5 is “The stop time is 60 seconds”. As shown in Notification Example 5, the output unit 21 can output, as the stop information, the remaining duration of a red signal light from the time at which the vehicle is stopped at the red signal light (i.e., the stop time), based on the signal information of the signal light device at the specified intersection. Accordingly, the driver can know the stop time when the vehicle is stopped at a red signal light, and therefore can recognize whether a desired operation other than driving can be performed.

Notification Example 6 is “Please travel at the current speed”. With Notification Example 6, the driver can know how he or she should drive the vehicle after the present time, and therefore can reliably stop the vehicle at an intersection. Note that Notification Examples 1 to 6 are merely examples, and the notification is not limited thereto. Notification Examples 1 to 6 may each be output alone, or may be output in combination.

The operation unit 14 has the function of an accepting unit, and accepts an operation for a vehicle stop request. For example, if the driver desires to stop the vehicle at a red signal light, the driver can perform the stop request operation.

The operation unit 14 may be a switch, or may be a touch panel. Note that the operation unit 14 may be provided with two dedicated switches, and one of the switches may be operated as an emergency switch only when the driver desires to stop the vehicle immediately, and the other switch may be operated as a normal switch when there is a sufficient time until the vehicle is stopped.

If the operation unit 14 accepts an operation, the determination unit 20 determines that an event that stops the vehicle has occurred. Accordingly, simply by performing the stop request operation, the driver can recognize that the vehicle can be stopped at a red signal light if the driver desires to stop the vehicle at a red signal light.

The navigation information acquisition unit 13 has the function of an operation history acquisition unit, and acquires an operation history of a navigation device (not shown). The operation history may be, for example, any of the operations performed by the driver that has been interrupted without being completed.

The determination unit 20 determines whether an event that stops the vehicle has occurred, based on the operation history acquired by the navigation information acquisition unit 13. Accordingly, if the driver has interrupted an operation of the navigation device, the driver can recognize that he or she can stop the vehicle at a red signal light without performing any special operation. This increases convenience for the driver.

The image capturing unit 15 includes a camera that can capture an image of the vehicle front and the vehicle interior (especially, the driver, etc.), and an image processing unit or the like. For example, by capturing an image of the driver with the image capturing unit 15 and executing image processing on the captured image, the driver can estimate the presence or absence of an operation (i.e., an event for which the driver desires to stop the vehicle) other than driving. The determination unit 20 can determine whether an event that stops the vehicle has occurred, according to the result of the image processing in the image capturing unit 15.

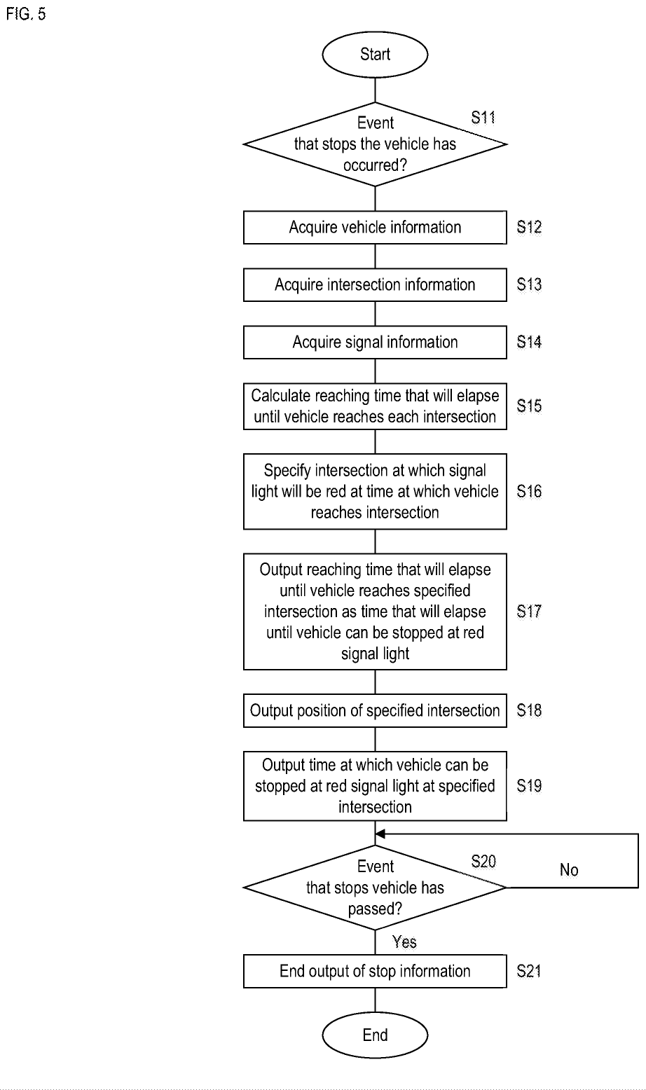

FIG. 5 is a flowchart showing an example of the processing procedure executed by the vehicle-mounted device 100 according to the present embodiment when the speed of the vehicle is not changed. For the sake of convenience, the following description will be given, assuming that the executor of the processing is the control unit 10. The control unit 10 determines whether an event that stops the vehicle has occurred (A1), and, if the event has not occurred (NO in S11), continues the processing in step S11. If the event has occurred (YES in S11), the control unit 10 acquires the vehicle information (S12), acquires the intersection information (S13), and acquires the signal information (S14).

The control unit 10 calculates the reaching time that will elapse until the vehicle reaches each of the intersections in the traveling direction (S15), and specifies the intersection at which the signal light is red at the time at which the vehicle reaches the intersection (S16). The control unit 10 outputs the reaching time that will elapse until the vehicle reaches the specified intersection as the time that will elapse until the vehicle can be stopped at a red signal light (S17).

The control unit 10 outputs the position of the specified intersection (S18), and outputs the time at which the vehicle can be stopped at a red signal light at the specified intersection (stop time) (S19). The control unit 10 determines whether the event that stops the vehicle has passed (S20). Here, it can be determined that the event that stops the vehicle has passed, for example, when the vehicle has been stopped before the intersection, when the driver has performed an operation for cancelling the notification, or when the vehicle has been stopped at the intersection.

If the event that stops the vehicle has not passed (NO in S20), the control unit 10 continues the processing in step S20. If the event that stops the vehicle has passed (YES in S20), the control unit 10 ends the output of the stop information (S21), and the processing ends.

In the above-described processing, only one or two of the processing in steps S17, S18, and S19 may be executed.

Next, the case where it is recommended to change the speed of the vehicle (the vehicle travels at a recommended speed) will be described. The traveling state of a vehicle to which the vehicle-mounted device 100 according to the present embodiment has been mounted is the same as that of the example shown in FIG. 2. The current speed of the vehicle is 60 km/h (16.7 m/sec).

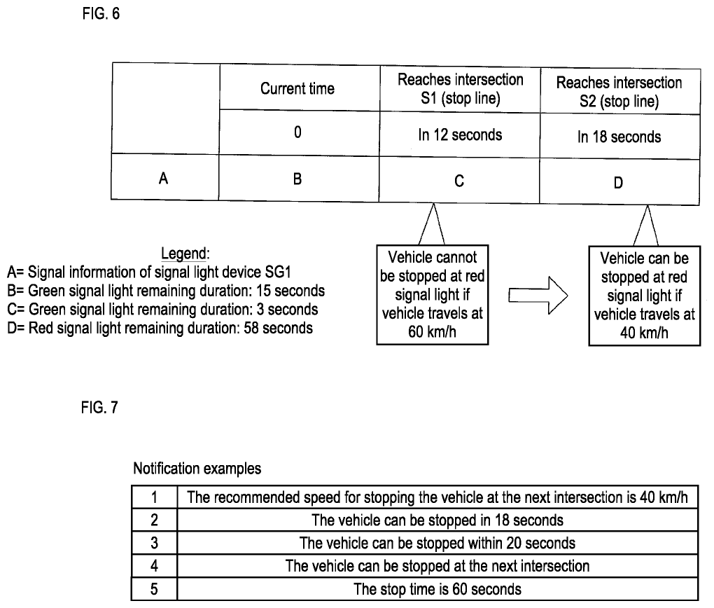

FIG. 6 is a diagram illustrating an example of the method for calculating a recommended speed by the vehicle-mounted device 100 according to the present embodiment. In the example shown in FIG. 6, the intersection S1 is the predetermined intersection. The predetermined intersection can be, for example, one of a plurality of intersections in the traveling direction of the vehicle that is located at the closest distance (the nearest intersection) (e.g., a desired intersection). If the driver desires to stop the vehicle as soon as possible (e.g., if the driver has operated the emergency switch), the nearest intersection can be the predetermined intersection.

The reaching time calculation unit 16 calculates, based on the position information and the speed information of the vehicle and the position information of a predetermined intersection, the reaching time that will elapse until the vehicle reaches the predetermined intersection. In the example in FIG. 6, assuming that the current time is 0, the vehicle will reach the intersection S1 (stop line) in 12 seconds.

The signal light color specifying unit 18 specifies the light color of the signal light device at the predetermined intersection at the time at which the reaching time has elapsed from the current time, based on the signal information of the signal light device at the predetermined intersection. In the example in FIG. 6, if the vehicle travels at 60 km/h (16.7 m/sec), the light color at the time at which the vehicle has reached the intersection S1 is green. Assuming that the current remaining duration of the green signal light is 15 seconds, the remaining duration of the green signal light at the time at which the vehicle has reached the intersection S1 is 3 seconds. That is, if the vehicle keeps traveling at the current speed, the vehicle cannot be stopped at a red signal light at the intersection S1.

Therefore, the recommended speed calculation unit 19 calculates a recommended speed for the vehicle to reach the predetermined intersection at a red signal light, based on the specified light color and the signal information of the signal light device. For example, it is assumed that the light color at the time at which the vehicle has reached the predetermined intersection is green, and the remaining duration of the green signal light is x seconds. It is also assumed that the duration of a yellow signal light is 1 second. By delaying the time when the vehicle reaches the predetermined intersection by (x+1) seconds, the vehicle can be stopped at a red signal light. The recommended speed calculation unit 19 calculates a speed V2 (<V1) at which the reaching time is increased by (x+1) seconds as the recommended speed.

In the example shown in FIG. 6, assuming that the recommended speed is 40 km/h (11.1 m/sec), the time that will elapse until the vehicle reaches the intersection S1 is 18 seconds, and the light color at the time at which the vehicle reaches the intersection S1 is red, and the remaining duration of the red signal light is 58 seconds. That is, by causing the vehicle to travel at 40 km/h, the vehicle can be stopped at a red signal light at the intersection S1. Note that the recommended speed is not limited to a speed slower than the original speed, and may be a speed faster than the original speed.

The output unit 21 outputs the recommended speed as the stop information. Accordingly, if the driver causes the vehicle to travel at the recommended speed, the driver can stop the vehicle at the nearest intersection (desired intersection) at the earliest timing as possible.

FIG. 7 is a diagram illustrating another example of the output of the stop information provided by the vehicle-mounted device 100 according to the present embodiment. Notification Example 1 is “The recommended speed for stopping the vehicle at the next intersection is 40 km/h”. Even though the vehicle cannot be stopped at the predetermined intersection at the current speed, notifying the recommended speed allows the driver to drive the vehicle at the recommended speed, thus making it possible to stop the vehicle at the nearest intersection (desired intersection) at the earliest timing.

Notification Example 2 is “The vehicle can be stopped in 18 seconds”, which is an example in which an accurate notification has been made of the time will that elapse until the vehicle can be stopped Notification Example 3 is “The vehicle can be stopped within 20 seconds”, which is an example in which a notification has been made with the time that will elapse until the vehicle can be stopped being an approximate value (e.g., the maximum value).

The output unit 21 outputs, as the stop information, the reaching time that will elapse until the vehicle reaches the predetermined intersection if the vehicle travels at the recommended speed. Accordingly, the driver can know when the vehicle can be stopped (the time that will elapse until the vehicle is stopped) if the driver desires to stop the vehicle at a red signal light, and therefore can recognize that the vehicle can be stopped at a red signal light.

Notification Example 4 is “The vehicle can be stopped at the next intersection”, which is an example in which a notification is made with an intersection (at what number intersection the vehicle can be stopped) as the position at which the vehicle can be stopped.

Notification Example 5 is “The stop time is about 60 seconds”. The output unit 21 outputs, as the stop information, the remaining duration of a red signal light from the time at which the vehicle is stopped at the red signal light if the vehicle travels at the recommended speed and is stopped at the red signal light at the predetermined intersection. Accordingly, the driver can know the stop time when the vehicle is stopped at a red signal light, and therefore can recognize whether a desired operation other than driving can be performed.

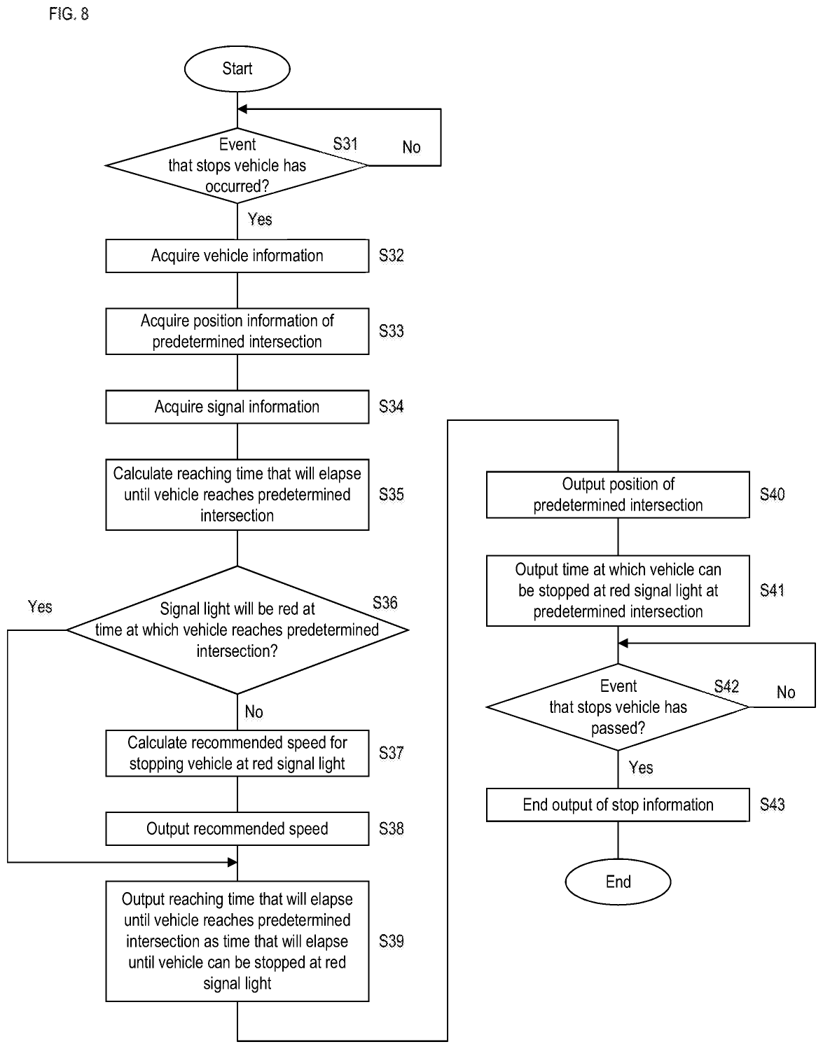

FIG. 8 is a flowchart showing an example of the processing procedure executed by the vehicle-mounted device 100 according to the present embodiment when the speed of the vehicle is changed. For the sake of convenience, the following description will be given, assuming that the executor of the processing is the control unit 10. The control unit 10 determines whether an event that stops the vehicle has occurred (S31), and, if such an event has not occurred (NO in S31), continues the processing in step S31. If such an event has occurred (YES in S31), the control unit 10 acquires the vehicle information (S32), acquires the intersection information (S33), and acquires the signal information (S34).

The control unit 10 calculates the reaching time that will elapse until the vehicle reaches each of the predetermined intersections (S35), and determines whether the signal light will be red at the time at which the vehicle reaches the intersection (S36). If the signal light will not be red at the time at which the vehicle reaches the intersection (NO in S36), the control unit 10 calculates the recommended speed for stopping the vehicle at a red signal light (S37), outputs the calculated recommended speed (S38), and executes the processing in step S39, which will be described below. If the signal light will not be red at the time at which the vehicle reaches the intersection (YES in S36), the control unit 10 executes the processing in the step S39, which will be described below, without executing the processing in steps S37 and S38. That is, the vehicle can be stopped at a red signal light at the predetermined intersection without changing the speed of the vehicle, and it is therefore not necessary to calculate the recommended speed.

The control unit 10 outputs the reaching time that will elapse until the vehicle reaches the predetermined intersection as the time that will elapse until the vehicle can be stopped at a red signal light (S39). The control unit 10 outputs the position of the predetermined intersection (S40), and outputs the time at which the vehicle can be stopped (stop time) at a red signal light at the predetermined intersection (S41).

The control unit 10 determines whether the event that stops the vehicle has passed (S42). If the event that stops the vehicle has not passed (NO in S42), the control unit 10 continues the processing in step S42. If the event that stops the vehicle has passed (YES in S42), the control unit 10 ends the output of the stop information (S43), and the processing ends.

In the above-described processing, only one or two of the processing in steps S39, S40, and S41 may be executed.

When the recommended speed is calculated in the above-described example, it is possible to acquire the speed limit from the image of a road sign captured by the image capturing unit 15, and make a notification of a recommended speed while taking the speed limit into consideration. Note that the speed limit may be acquired from a roadside device. Alternatively, information such as a traffic flow may be acquired from the roadside device, and a notification of the recommended speed may be made while taking the traffic flow into consideration.

The control method of the vehicle-mounted device 100 according to the present embodiment can also be implemented using a general-purpose computer including a CPU (processor), a RAM and the like. That is, the control method of the vehicle-mounted device 100 can be implemented on the computer by loading a computer program, in which various processing procedures are defined as shown in FIGS. 5 and 8, into the RAM included in the computer and the CPU (processor) executing the computer program.

The vehicle-mounted device according to the present embodiment includes: a vehicle information acquisition unit configured to acquire position information and speed information of a vehicle; an intersection information acquisition unit configured to acquire position information of one or a plurality of intersections in a traveling direction of the vehicle; a signal information acquisition unit configured to acquire signal information of a signal light device installed at the intersection; a determination unit configured to determine whether an event that stops the vehicle has occurred; and an output unit configured to output, if the determination unit determines that the event has occurred, stop information relating to a stop of the vehicle at a red signal light, based on the position information and the speed information of the vehicle, the position information of the intersection, and the signal information.

The computer program according to the present embodiment is for causing a computer to control a vehicle-mounted device, the program causing the computer to execute: processing for acquiring position information and speed information of a vehicle; processing for acquiring position information of one or a plurality of intersections in a traveling direction of the vehicle; processing for acquiring signal information of a signal light device installed at the intersection; processing for determining whether an event that stops the vehicle has occurred; and processing for outputting, if it is determined that the event has occurred, stop information relating to a stop of the vehicle at a red signal light, based on the position information and the speed information of the vehicle, the position information of the intersection, and the signal information.

The vehicle information acquisition unit acquires the position information and the speed information of a vehicle to which the vehicle-mounted device has been mounted. The position information may be an absolute position such as that of latitude and longitude, or may be a relative position from a reference position. The position information can be acquired from a positioning system (not shown) such as a global positioning system (GPS). The speed information can be acquired using a vehicle speed sensor. The speed information can also be calculated based on the position information of two locations and the time required to move between the two locations.

The intersection information acquisition unit acquires the position information of one or a plurality of intersections in the traveling direction of the vehicle. The position information of an intersection can be acquired from a roadside device such as an optical beacon and an intelligent transport system (ITS) radio set. The position information may be an absolute position such as that of latitude and longitude, or may be a relative position from a reference position.

The signal information acquisition unit acquires the signal information of the signal light device installed at the intersection. The signal information includes, for example, a cycle length, a split, an offset, and the display duration of each light color (e.g., green, yellow, red).

The determination unit determines whether an event that stops the vehicle has occurred. The event that stops the vehicle may be, for example, an event in which the driver desires to stop the vehicle to perform an operation (including, for example, the picking up a piece of baggage on the passenger seat or the back seat, operating a mobile phone, dressing or undressing, and cleaning a window or a mirror) other than driving.

If the determination unit determines that such an event has occurred, the output unit outputs stop information relating to a stop of the vehicle at a red signal light. The stop information is information relating to a vehicle stopping at a red signal light, and includes, for example, the time that will elapse until the vehicle is stopped (the time it will take to reach to the intersection), the stop position, the stop time (the remaining duration of the red signal light), and so forth. The stop position may be any information representing at which position (distance) the vehicle can be stopped from the current location of the vehicle, and may be, for example, the distance between the vehicle and an intersection at which the vehicle can be stopped, or information indicating at what number intersection in the traveling direction the vehicle can be stopped. The output of the stop information may be a display of characters or figures, or may be an audio output.

With the above-described configuration, the driver can obtain at least one of the time that elapses and the distance that is traveled until the vehicle stops at a red signal light, and therefore can recognize that the vehicle can be stopped at a red signal light.

The vehicle-mounted device according to the present embodiment includes: a reaching time calculation unit configured to calculate, based on the position information and the speed information of the vehicle and the position information of each of the plurality of intersections, reaching times at which the vehicle reaches the respective intersections; and an intersection specifying unit configured to specify, based on signal information of the signal light device at each of the intersections, an intersection at which a signal light of the signal light device will be red at a time at which the corresponding reaching time has elapsed from the current time, wherein the output unit outputs a reaching time that will elapse until the vehicle reaches the intersection specified by the intersection specifying unit.

The reaching time calculation unit calculates, based on the position information and the speed information of the vehicle and the position information of each of the plurality of intersections, the reaching times that elapse until the vehicle reaches the respective intersections. The reaching time that will elapse until the vehicle reaches each intersection can be calculated based on the distance between the vehicle and the intersection, and the speed of the vehicle.

The intersection specifying unit specifies, based on the signal information of the signal light device at each of the intersections, the intersection at which the signal light will be red at the time at which the corresponding reaching time has elapsed from the current time. For example, it is assumed that intersections S1 and S2 are present in this order from the front side (the upstream side) of the vehicle in the traveling direction of the vehicle. Assuming that the light color of the signal light device is green at the intersection S1 at the time at which the vehicle reaches the intersection S1, and the light color of the signal light device is red at the intersection S2 at the time at which the vehicle reaches the intersection S2, the intersection specifying unit specifies the intersection S2.

The output unit outputs the reaching time that will elapse until the vehicle reaches the specified intersection. Accordingly, the driver can know when the vehicle can be stopped (the time that will elapse until the vehicle is stopped) if the driver desires to stop the vehicle at a red signal light, and therefore can recognize that the vehicle can be stopped at a red signal light.

In the vehicle-mounted device according to the present embodiment, the output unit outputs the position of the intersection specified by the intersection specifying unit.

The output unit outputs the position of the specified intersection. Accordingly, the driver can know where the vehicle can be stopped (the distance that is traveled until the vehicle is stopped) if the driver desires to stop the vehicle at a red signal light, and therefore can recognize that the vehicle can be stopped at a red signal light.

In the vehicle-mounted device according to the present embodiment, the output unit outputs the remaining duration of a red signal light from a time at which the vehicle has been stopped at the red signal light, based on the signal information of the signal light device at the intersection specified by the intersection specifying unit.

The output unit outputs the remaining duration of a red signal light from the time at which the vehicle is stopped at the red signal light, based on the signal information of the signal light device at the specified intersection. Accordingly, the driver can know the stop time when the vehicle is stopped at a red signal light, and therefore can recognize whether a desired operation other than driving can be performed.

The vehicle-mounted device according to the present embodiment includes: a reaching time calculation unit configured to calculate, based on the position information and the speed information of the vehicle and position information of a predetermined intersection, a reaching time that will elapse until the vehicle reaches the predetermined intersection; a signal light color specifying unit configured to specify, based on the signal information of the signal light device at the predetermined intersection, a light color of the signal light device at the predetermined intersection at a time at which the reaching time has elapsed from the current time; and a recommended speed calculation unit configured to calculate, based on the light color specified by the signal light color specifying unit and the signal information of the signal light device, a recommended speed for the vehicle to reach the predetermined intersection at a red signal light.

The reaching time calculation unit calculates, based on the position information and the speed information of the vehicle and the position information of a predetermined intersection, the reaching time that will elapse until the vehicle reaches the predetermined intersection. The predetermined intersection can be, for example, one of a plurality of intersections in the traveling direction of the vehicle that is located at the closest distance (the nearest intersection) (e.g., a desired intersection). If the driver desires to stop the vehicle as soon as possible, the vehicle can be stopped at the predetermined intersection.

The signal light color specifying unit specifies the light color of the signal light device at the predetermined intersection at the time at which the reaching time has elapsed from the current time, based on the signal information of the signal light device at the predetermined intersection. For example, it is assumed that the light color when the vehicle has reached the predetermined intersection is green if the vehicle travels at a speed V1.

The recommended speed calculation unit calculates a recommended speed for the vehicle to reach the predetermined intersection at a red signal light, based on the specified light color and the signal information of the signal light device. For example, it is assumed that the light color is green at the time at which the vehicle has reached the predetermined intersection, and the remaining duration of the green signal light is x seconds. It is also assumed that the duration of a yellow signal light is 1 second. By delaying the time at which the vehicle reaches the predetermined intersection by (x+1) seconds, the vehicle can be stopped at a red signal light. The recommended speed calculation unit calculates a speed V2 (<V1) at which the reaching time is increased by (x+1) seconds as the recommended speed.

If the driver causes the vehicle to travel at the recommended speed, the driver can stop the vehicle at the nearest intersection (desired intersection) at the earliest timing as is possible.

In the vehicle-mounted device according to the present embodiment, the output unit outputs a reaching time that will elapse until the vehicle reaches the predetermined intersection if the vehicle travels at the recommended speed.

The output unit outputs the reaching time that will elapse until the vehicle reaches the predetermined intersection if the vehicle travels at the recommended speed. Accordingly, the driver can know when the vehicle can be stopped (the time that will elapse until the vehicle is stopped) if the driver desires to stop the vehicle at a red signal light, and therefore can recognize that the vehicle can be stopped at a red signal light.

In the vehicle-mounted device according to the present embodiment, the output unit outputs the remaining duration of a red signal light from a time at which the vehicle has been stopped at the red signal light if the vehicle travels at the recommended speed and is stopped at the predetermined intersection at the red signal light.

The output unit outputs the remaining duration of a red signal light from the time at which the vehicle is stopped at the red signal light if the vehicle travels at the recommended speed and is stopped at the red signal light at the predetermined intersection. Accordingly, the driver can know the stop time when the vehicle is stopped at a red signal light, and therefore can recognize whether a desired operation other than driving can be performed.

The vehicle-mounted device according to the present embodiment includes: an accepting unit configured to accept an operation for a vehicle stop request, wherein the determination unit determines that the event has occurred if the accepting unit accepts the operation.

The accepting unit accepts an operation for a vehicle stop request. For example, if the driver desires to stop the vehicle at a red signal light, the driver can perform the stop request operation. The accepting unit may be a switch, or may be a touch panel.

If the accepting unit accepts the operation, the determination unit determines that an event has occurred. Accordingly, simply by performing the stop request operation, the driver can recognize that the vehicle can be stopped at a red signal light if the driver desires to stop the vehicle at a red signal light.

The vehicle-mounted device according to the present embodiment includes: an operation history acquisition unit configured to acquire an operation history of a navigation device, wherein the determination unit determines whether the event has occurred, based on the operation history acquired by the operation history acquisition unit.

The operation history acquisition unit acquires an operation history of a navigation device. The operation history may be, for example, any of the operations performed by the driver that have been interrupted and not completed.

The determination unit determines whether an event has occurred, based on the acquired operation history. Accordingly, if the driver has interrupted an operation of the navigation device, the driver can recognize that he or she can stop the vehicle at a red signal light without performing any special operation.

It should be appreciated that the embodiment and examples disclosed above are to be construed in all respects as illustrative and not limiting. The scope of the present disclosure is defined by the claims, rather than the embodiment and examples above, and is intended to include all modifications and variations which fall within the scope of the claims and the meaning and scope of equivalents thereof.

1. A vehicle-mounted device comprising:
a vehicle information acquisition unit configured to acquire position information and speed information of a vehicle;
an intersection information acquisition unit configured to acquire position information of one or a plurality of intersections in a traveling direction of the vehicle;
a signal information acquisition unit configured to acquire signal information of a signal light device installed at the intersection;
a determination unit configured to determine whether an event that stops the vehicle has occurred; and
an output unit configured to output, if the determination unit determines that the event has occurred, stop information relating to a stop of the vehicle at a red signal light, based on the position information and the speed information of the vehicle, the position information of the intersection, and the signal information.

2. The vehicle-mounted device according to claim 1, comprising:
a reaching time calculation unit configured to calculate, based on the position information and the speed information of the vehicle and the position information of each of the plurality of intersections, reaching times at which the vehicle reaches the respective intersections; and
an intersection specifying unit configured to specify, based on signal information of the signal light device at each of the intersections, an intersection at which a signal light of the signal light device will be red at a time at which the corresponding reaching time has elapsed from the current time,
wherein the output unit outputs a reaching time that will elapse until the vehicle reaches the intersection specified by the intersection specifying unit.

3. The vehicle-mounted device according to claim 1,
wherein the output unit outputs the position of the intersection specified by the intersection specifying unit.

4. The vehicle-mounted device according to claim 1, wherein the output unit outputs the remaining duration of a red signal light from a time at which the vehicle has been stopped at the red signal light, based on the signal information of the signal light device at the intersection specified by the intersection specifying unit.

5. The vehicle-mounted device according to claim 1, comprising:
a reaching time calculation unit configured to calculate, based on the position information and the speed information of the vehicle and position information of a predetermined intersection, a reaching time that will elapse until the vehicle reaches the predetermined intersection;
a signal light color specifying unit configured to specify, based on the signal information of the signal light device at the predetermined intersection, a light color of the signal light device at the predetermined intersection at a time at which the reaching time has elapsed from the current time; and
a recommended speed calculation unit configured to calculate, based on the light color specified by the signal light color specifying unit and the signal information of the signal light device, a recommended speed for the vehicle to reach the predetermined intersection at a red signal light.

6. The vehicle-mounted device according to claim 5, wherein the output unit outputs a reaching time that will elapse until the vehicle reaches the predetermined intersection if the vehicle travels at the recommended speed.

7. The vehicle-mounted device according to claim 5, wherein the output unit outputs the remaining duration of a red signal light from a time at which the vehicle has been stopped at the red signal light if the vehicle travels at the recommended speed and is stopped at the predetermined intersection at the red signal light.

8. The vehicle-mounted device according claim 1, comprising:
an accepting unit configured to accept an operation for a vehicle stop request,
wherein the determination unit determines that the event has occurred if the accepting unit accepts the operation.

9. The vehicle-mounted device according to claim 1, comprising;
an operation history acquisition unit configured to acquire an operation history of a navigation device,
wherein the determination unit determines whether the event has occurred, based on the operation history acquired by the operation history acquisition unit.

10. A computer program for causing a computer to control a vehicle-mounted device,
the program causing the computer to execute;
processing for acquiring position information and speed information of a vehicle;
processing for acquiring position information of one or a plurality of intersections in a traveling direction of the vehicle;
processing for acquiring signal information of a signal light device installed at the intersection;
processing for determining whether an event that stops the vehicle has occurred; and
processing for outputting, if it is determined that the event has occurred, stop information relating to a stop of the vehicle at a red signal light, based on the position information and the speed information of the vehicle, the position information of the intersection, and the signal information.
